(19) United States
(12) Patent Application Publication
(10) Pub. No.: US 2006/0206582 A1
(43) Pub. Date: Sep. 14, 2006

(54) PORTABLE MUSIC DEVICE WITH SONG TAG CAPTURE

(76) Inventor: David Finn, Tourmakeady (IE)

Correspondence Address: D.A. STAUFFER PATENT SERVICES LLC, 1006 MONTFORD ROAD, CLEVLAND HTS., OH, 44121-2016, US

(21) Appl. No.: 11/381,389

(22) Filed: May 3, 2006

Related U.S. Application Data
(63) Continuation-in-part of application No. 10/990,296, filed on Nov. 16, 2004.
(63) Continuation-in-part of application No. 11/355,264, filed on Feb. 15, 2006.
(60) Provisional application No. 60/685,503, filed on May 27, 2005.
(60) Provisional application No. 60/691,337, filed on Jun. 16, 2005.
(60) Provisional application No. 60/708,707, filed on Aug. 16, 2005.
(60) Provisional application No. 60/725,818, filed on Oct. 12, 2005.
(60) Provisional application No. 60/734,409, filed on Nov. 8, 2005.
(60) Provisional application No. 60/520,698, filed on Nov. 17, 2003.
(60) Provisional application No. 60/562,204, filed on Apr. 14, 2004.
(60) Provisional application No. 60/602,595, filed on Aug. 18, 2004.
(60) Provisional application No. 60/652,895, filed on Feb. 15, 2005.
(60) Provisional application No. 60/660,398, filed on Mar. 10, 2005.
(60) Provisional application No. 60/664,974, filed on Mar. 24, 2005.

(51) Int. Cl. G06F 15/16

(52) U.S. Cl. 709/217

(57) ABSTRACT

A portable music device (PMD) for capturing song tags while monitoring a broadcast (via Internet or radio), either on the PMD (either via an Internet connection or via a built-in FM radio receiver), or on a nearby radio (by detecting the station to which the nearby radio is tuned). The user can use the captured song tags to download song files, either on the Internet or in a physical music shop. Song tags may be ID3-type tags modified to include a link to a web address of a server for downloading songs. The PMD may also store credits for paying for the songs, and may include a contactless interface for secure payment.

### CROSS-REFERENCE TO RELATED APPLICATIONS

Priority is claimed from the following:

This is a non-provisional filing of U.S. Ser. No. 60/685,503 filed May 27, 2005.

This is a non-provisional filing of U.S. Ser. No. 60/691,337 filed Jun. 16, 2005.

This is a non-provisional filing of U.S. Ser. No. 60/708,707 filed Aug. 16, 2005.

This is a non-provisional filing of U.S. Ser. No. 60/725,818 filed Oct. 12, 2005.

This is a non-provisional filing of U.S. Ser. No. 60/734,409 filed Nov. 08, 2005.

This is a continuation-in-part of U.S. Ser. No. 10/990,296 filed Nov. 16, 2004.

This is a continuation-in-part of U.S. Ser. No. 11/355,264 filed Feb. 15, 2006.

all of which are incorporated by reference herein, and all of which name Finn as an inventor.

### TECHNICAL FIELD OF THE INVENTION

This invention relates generally to Internet radio, and to listening to and downloading music.

### BACKGROUND OF THE INVENTION

Internet Radio

A Wi-Fi enabled radio allows a user to access Internet radio stations from any wireless network (such as 802.11 b/g) and broadband (ADSL) connection which stream (Real Audio, MP3 & WMA) both live and listen again radio content over the World Wide Web. The technology represents a shift from AM/FM radio to DAB (Digital Audio Broadcasting), which is considered a revolution in audio entertainment.

In application, a Wi-Fi radio links into an existing Wi-Fi network and uses the wireless or broadband connection to access the Internet radio Gateway. The Wi-Fi radio then uploads channel listings alphabetically by country and genre.

Tagging

Broadcasted music tracks are digital audio files, which can contain the audio track and text related information. The process of including information other than sound into these digital audio files is commonly referred to as “ID3 tagging”.

Tuned Frequency Detection

A super heterodyne receiver mixes incoming high frequency signals with a signal from an internal local oscillator to produce a lower, fixed-frequency signal (Intermediate Frequency) that is used for audio processing. (The incoming signal is a variable frequency, the local oscillator signal is also a variable frequency and the IF is at a fixed selected frequency. When you are tuning for a station, you are tuning the internal local oscillator.) Although great care is taken to shield the local oscillator from the mixer, some of this signal leaks back up the aerial/cable and is transmitted for a short distance. The frequency of the local oscillator is always a set frequency (the IF frequency) different than the frequency being received (i.e., the station being listened to). Therefore, the leaking local oscillator signal tells not only whether a radio (or TV) is switched on or not, but it also reveals what station is being listened to. In other words, in a sense, a radio or TV receiver also acts as a transmitter (but only simple frequency signals, without modulation). This concept is used to catch unauthorized use of radios and televisions in places (countries such as Germany, England) where a radio/TV tax is imposed for possession of radios/TVs.

A number of distinct communication interfaces and protocols are known, and are discussed herein, including, but not limited to:
contact (or wired, or mechanical), an example of which is USB
contactless, examples of which are ISO 14443, ISO 15693 and NFC
wireless, examples of which are IEEE 802.11, Zigbee, Bluetooth, UWB
radio (RF), examples of which are AM and FM radio
cellular, an example of which is CDMA
TCP/IP, including telephone modems and ADSL modems
human interfaces, including display, keyboard, switches, microphone, headphone

Contact Interfaces

As used herein, “contact interfaces” refers to mechanical (wired) connections between one device and another, such as via a cable or inserting a module into a socket. The following are examples of contact interfaces and/or devices that typically connect via a contact interface.
USB Short for “Universal Serial Bus”. USB is a serial bus standard (standardized communications protocol) that enables data exchange between electronic devices. USB supports data transfer rates of up to 12 Mbps (megabits per second). A single USB port can be used to connect up to 127 peripheral devices, such as mice, modems, and keyboards. USB also supports plug-and-play installation and “hot plugging”. USB is expected to completely replace serial and parallel ports. Hi-Speed USB (USB 2.0) similar to FireWire technology, supports data rates up to 480 Mbps.
Ethernet A local-area network (LAN) architecture developed by Xerox Corporation in cooperation with DEC and Intel in 1976. Ethernet uses a bus or star topology and supports data transfer rates of 10 Mbps. The Ethernet specification served as the basis for the IEEE 802.3 standard, which specifies the physical and lower software layers. Ethernet uses the CSMA/CD access method to handle simultaneous demands. It is one of the most widely implemented LAN standards. A newer version of Ethernet, called 100Base-T (or Fast Ethernet), supports data transfer rates of 100 Mbps. And the newest version, Gigabit Ethernet supports data rates of 1 gigabit (1,000 megabits) per second.
IEEE 1394 IEEE 1394 (also known as FireWire® and iLINK™) is a high-bandwidth isochronous (real-time) interface for computers, peripherals, and consumer electronics products such as camcorders, VCRs, printers, PCs, TVs, and digital cameras. With IEEE 1394-compatible products and systems, users can transfer video or still images from a camera or camcorder to a printer, PC, or television (TV), with no image degradation.
SD Short for “Secure Digital”. SD is a technology standard for providing portable devices with non-volatile memory/storage and peripheral I/O expansion capability. On some devices this standard is implemented in the form of SD memory expansion cards, used to store digital information like applications, databases, photos, text, audio, video or MP3 music files, and an SD/SDIO expansion slot. The SD standard makes it possible to transfer information between devices that support SD expansion cards (e.g. transfer photos between a digital camera and a PDA by exchanging the SD expansion card), assuming both devices support the file format used for the transferred information (e.g. JPEG image file).
SDIO Short for “Secure Digital Input/Output”. SDIO is a part of the SD memory specification. It enables I/O (input/output) expansion for add-ons such as serial, modem, camera or GPS (global positioning system) cards. Whereas SD is only used for storage expansion cards, an SDIO capable expansion slot can also support SD expansion cards, while an SD-capable slot may not support an SDIO expansion card.
SIM Short for “Secure Identity Module” or “Subscriber Identification/Identity Module”. A SIM card inscribed with a customer's information and designed to be inserted into any mobile telephone. Usually SIM card phones work by GSM technology. The SIM card contains a user's GSM mobile account information. SIM cards are portable between GSM devices—the user's mobile subscriber information moves to whatever device houses the SIM.

Wireless Interfaces

As used herein, “wireless interfaces” refers to ultra-high radio frequency (RF) connections between one device and another, typically over a moderate distance, such as up to 100 meters. The following are examples of wireless interfaces and/or devices that typically connect via a wireless interface.
wireless Technology that allows a user to communicate and/or connect to the Internet or mobile phone networks without physical wires. Wi-Fi, Bluetooth®, CDMA and GSM are all examples of wireless technology.
Wi-Fi Short for “Wireless Fidelity”. Wireless technology, also known as 802.11b, enables you to access the Internet, to send and receive email, and browse the Web anywhere within range of a Wi-Fi access point, or HotSpot.
Bluetooth A wireless technology developed by Ericsson, Intel, Nokia and Toshiba that specifies how mobile phones, computers and PDAs interconnect with each other, with computers, and with office or home phones. The technology enables data connections between electronic devices in the 2.4 GHz range at 720 Kbps (kilo bits per second) within a 30-foot range. Bluetooth uses low-power radio frequencies to transfer information wirelessly between similarly equipped devices.
UWB UWB is short for “Ultra Wide Band”. UWB is a wireless communications technology that transmits data in short pulses which are spread out over a wide swath of spectrum. Because the technology does not use a single frequency, UWB enjoys several potential advantages over single-frequency transmissions. For one, it can transmit data in large bursts because data is moving on several channels at once. Another advantage is that it can share frequencies, which is used by other applications because it transmits only for extremely short periods, which do not last long enough to cause interference with other signals.
WLAN Short for “wireless local-area network”. Also referred to as LAWN. A WLAN is a type of local-area network that uses high-frequency radio waves rather than wires for communication between nodes (e.g., between PCs).
IEEE 802.11 The IEEE standard for wireless Local Area Networks (LANs). It uses three different physical layers, 802.11a, 802.11b and 802.11g.

Contactless Interfaces

As used herein, “contactless interfaces” refers to high radio frequency (RF) connections between one device and another, typically over a very short distance, such as only up to 50 cm. The following are examples of contactless interfaces and/or devices that typically connect via a contactless interface.
ISO 14443 ISO 14443 RFID cards; contactless proximity cards operating at 13.56 MHz in up to 10 cm distance. ISO 14443 defines the contactless interface smart card technical specification.
ISO 15693 ISO standard for contactless integrated circuits, such as used in RF-ID tags. ISO 15693 RFID cards; contactless vicinity cards operating at 13.56 MHz with a read/write range of up to 100 cm. (ISO 15693 is typically not used for financial transactions because of its relatively long range as compared with ISO 14443.)
NFC Short for “Near Field Communication”. NFC is a contactless connectivity technology that enables short-range communication between electronic devices. If two devices are held close together (for example, a mobile phone and a personal digital assistant), NFC interfaces establish a peer-to-peer protocol, and information such as phone book details can be passed freely between them. NFC devices can be linked to contactless smart cards, and can operate like a contactless smart card, even when powered down. This means that a mobile phone can operate like a transportation card, and enable fare payment and access to the subway. NFC is an open platform technology standardized in ECMA (European Computer Manufacturers Association) 340 as well as ETSI (European Telecommunications Standards Institute) TS 102 190 V1.1.1 and ISO/IEC 18092. These standards specify the modulation schemes, coding, transfer speeds, and frame format of the RF interface of NFC devices, as well as initialization schemes and conditions required for data collision-control during initialization—for both passive and active modes.
RFID Short for “Radio Frequency Identification”. An RFID device interacts, typically at a limited distance, with a “reader”, and may be either “passive” (powered by the reader) or “active” (having its own power source, such as a battery).

Wireless versus Contactless Interfaces

Wireless and Contactless are two types of radio frequency (RF) interfaces. In a most general sense, both are “wireless” in that they do not require wires, and that they use RF. However, in the art to which this invention most nearly pertains, the terms “wireless” and “contactless” have two very different meanings and two very different functionalities.

The wireless interfaces of interest in the present invention are principally WLAN, Zigbee, Bluetooth and UWB. These wireless interfaces operate at a distance of several meters, generally for avoiding “cable spaghetti” for example, Bluetooth for headsets and other computer peripherals. WLAN is typically used for networking several computers in an office.

The contactless interfaces of interest in the present invention are principally RFID contactless interfaces such as ISO 14443, 15693 and NFC. RFID operates at a maximum distance of 100 cm for the purpose of identification in applications such as access control. In a payment (financial transaction) application, the distance is restricted to 10 cm. For example, a contactless RFID smart card protocol according to ISO 14443, can be used for private, secure financial transactions in “real world” applications such as payment at a retailer.

Wireless and contactless use different communications protocols with different capabilities and are typically used for very different purposes. Note, for example, that 100 cm (ISO 15693, an RFID contactless protocol) is considered to be too great a distance to provide appropriate security for (contactless) financial transactions. But 100 cm would not be enough to provide a (wireless) network between office computers! Additionally, generally, contactless technology is primarily passive (having no power source of its own), deriving power to operate from the electromagnetic field generated by a nearby reader. Also, contactless technology, using the smart card protocol, is used for secure identification, authentication and payment. Wireless technologies, on the other hand, generally require their own power source (either batteries, or plugged in) to operate. Contactless is different than wireless; different protocol, different signal characteristics, different utility, different energy requirements, different capabilities, different purposes, different advantages, different limitations.

Radio Interfaces

As used herein, “radio interfaces” refers to RF links between a transmitter, such as a radio broadcaster, and a receiver, such as a user's car radio or entertainment center, typically many miles away. Usually, the links being considered here are one way, from transmitter to receiver. The following are examples of RF interfaces and/or devices that typically connect via a radio interface.
FM Frequency modulation is a form of modulation, which represents information as variations in the instantaneous frequency of a carrier wave. (Contrast this with amplitude modulation (AM), in which the amplitude of the carrier is varied while its frequency remains constant.) In analog applications, the carrier frequency is varied in direct proportion to changes in the amplitude of an input signal. Digital data can be represented by shifting the carrier frequency among a set of discrete values, a technique known as frequency-shift keying. FM is commonly used at VHF radio frequencies for high-fidelity broadcasts of music and speech. Normal (analog) TV sound is also broadcast using FM.

Cellular Interfaces

As used herein, “cellular interfaces” refers to RF links between a device such as a cellular telephone, and a base station (BS), typically up to tens of kilometers away. The following are examples of cellular interfaces and or devices that typically connect via a cellular interface.
CDMA Short for “Code-Division Multiple Access”. CDMA is a digital cellular technology that uses spread-spectrum techniques. Unlike competing systems, such as GSM, that use TDMA, CDMA does not assign a specific frequency to each user. Instead, every channel uses the full available spectrum. Individual conversations are encoded with a pseudo-random digital sequence.
GSM/GPRS Short for “Global System for Mobile Communications”/“General Packet Radio Service”. A type of mobile phone network used throughout most of the world. GPRS enabled networks offer ‘always-on’, higher capacity, Internet-based content and packet-based data services. This enables services such as color Internet browsing, email on the move, powerful visual communications, multimedia messages and location-based services. Used by AT&T, Cingular Wireless and T-Mobile (and others) in the USA and Rogers Wireless and Fido in Canada. GSM 11.11 is a specification for Global System for Mobile communications.
Cell phone Also referred to as “mobile phone” or “handset”. A cell phone today is a mobile communication device used not only for making calls, but it is lately used as media device, transaction device, data storage device using SD or MMC cards for that. So called smart cellular phones are also Internet enabled devices allowing the user to connect to and browse the World Wide Web, send and receive email, and some also incorporate the functionality of a PDA.

TCP/IP Interfaces

As used herein, “TCP/IP Interfaces” refers to links between a device such as a home computer (PC) and a server, for accessing the Internet. The following are examples of TCP/IP interfaces and or devices that typically connect via a TCP/IP interface.
DSL Short for “Digital Subscriber Line”. DSL technologies use sophisticated modulation schemes to pack data onto copper wires. They are sometimes referred to as last-mile technologies because they are used only for connections from a telephone switching station to a home or office, not between switching stations. The two main categories of DSL are ADSL (asymmetric DSL) and SDSL (symmetric DSL). ADSL supports data rates of 1.5 to 9 Mbps (million bits per second) when receiving data (known as the downstream rate) and from 16 to 640 Kbps when sending data (known as the upstream rate). Two other types of DSL technologies are High-data-rate DSL (HDSL) and Very high DSL (VDSL).
Modem Short for “modulator-demodulator”. A modem is a device or program that enables a computer to transmit data over, for example, telephone or cable lines. Computer information is stored digitally, whereas information transmitted over telephone lines is transmitted in the form of analog waves. A modem converts between these two forms. There is one standard interface for connecting external modems to computers called RS-232. While the modem interfaces are standardized, a number of different protocols for formatting data to be transmitted over telephone lines exist.
RJ-45 Short for “Registered Jack-45”. RJ-45 is an eight-wire connector used commonly to connect computers onto a local-area network (LAN), especially Ethernets. RJ-45 connectors look similar to the ubiquitous RJ-11 connectors used for connecting telephone equipment, but they are somewhat wider.
TCP/IP Short for “Transmission Control Protocol/Internet Protocol”. TCP/IP has become the basic protocol that defines how information is exchange over the Internet. IP software sets the rules for data transfer over a network, while TCP software ensures the safe and reliable transfer of data. The abbreviation TCP/IP is commonly used to represent the whole suite of internetworking software.

Human Interfaces

As used herein, “Human Interfaces” refers instrumentalities, which permit a user to operate a device, such as input devices and output devices, including visual, audio and tactile devices and transducers.
Display typically a flat panel LCD, OLED or TFT screen capable of displaying text and images.
Lights typically an LED light indicating the status of the device (such as ON or OFF).
Mouse typically, a device for converting X and Y motion into horizontal and vertical movement of a cursor (or an icon) on a display screen.
Joystick typically a two-axis device for converting mechanical motion of a lever into horizontal and vertical movement of a cursor (or an icon) on a display screen.
Switches any buttons, keys, actuators, or the like for making inputs, such as turning a device ON or OFF, selecting features or modes, and the like.
Keyboard typically an array of many touch switches for making alphanumeric inputs.
mic a connection (jack) for an external microphone.
line in a connection (jack) for connecting to the “line out” output of another audio device.
spkr a connection (jack) for an external speaker (or headphones).
line out a connection (jack) for connecting to the “line in” input of another audio device.
annunciator a simple signal to sound transducer for making beeps, tones, clicks, and the like.
microphone a sound to signal transducer for signalizing sounds, voices, music, and the like.
speaker a signal to sound transducer for reproducing sounds, voices, music, and the like.

Glossary & Definitions

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks (®).
802.11n In January 2004, IEEE announced that it will develop a new standard for wide-area wireless networks. The real speed would be 100 Mbit/s (even 250 Mbit/s in PHY level), and so up to 4-5 times faster than 802.11g, and perhaps 50 times faster than 802.11b. As projected, 802.11n will also offer a better operating distance than current networks. The standardisation progress is expected to be completed by the end of 2006. 802.11n builds upon previous 802.11 standards by adding MIMO (multiple-input multiple-output). The additional transmitter and receiver antennas allow for increased data throughput through spatial multiplexing and increased range by exploiting the spatial diversity through coding schemes like Alamouti coding.
AAC Short for Advanced Audio Coding, one of the audio compression formats defined by the MPEG-2 standard. AAC is sometimes referred to as MPEG-2 NBC (not backwards compatible) because it is not compatible with the MPEG-1 coding scheme. AAC boasts higher quality audio reproduction than MP3 and requires 30% less data to do so.
AC-3 The coding system used by Dolby Digital. The two terms, AC-3 and Dolby Digital, are often used interchangeably.
ADPCM Short for Adaptive Differential Pulse Code Modulation, a form of pulse code modulation (PCM) that produces a digital signal with a lower bit rate than standard PCM. ADPCM produces a lower bit rate by recording only the difference between samples and adjusting the coding scale dynamically to accommodate large and small differences. Some applications use ADPCM to digitise a voice signal so voice and data can be transmitted simultaneously over a digital facility normally used only for one or the other.
AF short for audio frequency. AF is sound that is within the normal range of human hearing, usually between 20 hertz (Hz) and 20 kilohertz (kHz).
AVI Short for Audio Video Interleave, the file format for Microsoft Video for Windows standard.
Bits per second (bps)—a measurement of the speed at which data is sent over transmission lines. a bit is the smallest unit of information on a computer see also: bytes per second (BPS).
Bit rate the average number of bits that one second of audio data will consume. Standard MP3 bit rates are 64 kbps (kilobits per second), 96 kbps, 128 kbps, and 160 kbps. The higher the bit rate, the better the sound quality. MP3 files at 128 kbps are considered to be “CD-quality”.
BPS short for bytes per second. BPS (upper case) is a rate of data transfer, not to be confused with bits per second (bps, lower case). A byte is a number of bits that are usually treated as a unit. Bytes of eight bits usually represent either one letter or two numerals.
Burn the process of writing a DVD, CD-R, or CD-RW. CD and DVD writers are sometimes called burners.
CBR short for constant bit rate. CBR is a type of encoding that maintains a fixed bit rate throughout a file, so that data is sent in a steady stream. But because more complex passages may be encoded with fewer than necessary bits, and relatively simple passages may be encoded with more bits than are necessary, CBR can potentially result in lower-quality sound see also: variable bit rate (VBR).
CD short for Compact Disc. A single-layer, single-sided CD is capable of storing approximately 800 MB of data, which corresponds to approximately 20-30 .wav format songs or 200-300 MP3 songs.
CDDB an online database of music CD information. When you play a music CD on a CDDB-enabled player such as the HP media center PC, the CD is automatically identified and its information downloaded, including the artist, track lists, credits, etc.
CD quality the quality of a music recording on a standard CD, in wav format. CD-quality is often used as a measuring stick against which other audio file formats (such as MP3, WMA, RealAudio or Vorbis audio format) are compared.
CD-R short for CD-recordable. A CD-R can store data as well as digital audio files. However information can only be recorded once; the disc cannot be reused.
CD-RW short for CD-rewritable. With CR-RW you can write, rewrite, and erase more than a thousand times on this medium. The data on cd-rw discs is only readable by CR-RW drives; sometimes computers need the identical software that was used to create a disc in order to read it.
CODEC Short for compressor/de-compressor, a codec is any technology for compressing and decompressing data. CODECs can be implemented in software, hardware, or a combination of both. Some popular CODECs for computer video include MPEG, Indeo and Cinepak.
Compression the process of reducing the range of audio signals in a recording, thus decreasing the size of the file. MP3 compression eliminates frequencies inaudible to the human ear, though a bit rate below 128 kbps produces a discernible loss in sound quality.
DAB Digital audio broadcasting or DAB is a developing technology for broadcasting audio programming in digital form. Broadcast radio has been in widespread use since the 1920s, and to this time has remained largely based on the analog “amplitude modulation” (AM) technologies used at the beginning and the “frequency modulation” (FM) technologies introduced in the mid-20th Century. The objective of converting to digital systems is to enable higher fidelity, greater noise immunity, and new services. However, because FM with good reception provides hi-fi sound, digital radio systems around the world rarely match FM's level of audio quality. The acronym DAB is used both to identify the generic technology of digital audio broadcasting, and specific technical standards, particularly the Eureka 147 standard described below. Standardization of DAB technology is promoted by the World DAB Forum, which represents more than 30 countries, not including the United States. Some marketing confusion has been engendered by the use of the term “digital”—consumers may associate this with a digital method of tuning, which is commonly found on analogue radios with LCDs, rather than a digital signal.
DivX (1) Short for Digital video express, a new DVD-ROM format promoted by several large Hollywood companies, including Disney, Dreamworks SKG, Paramount and Universal. With Divx, a movie (or other data) loaded onto a DVD-ROM is playable only during a specific time frame, typically two days. As soon as you begin playing a Divx disc, the counter starts. Each Divx player is connected to a telephone outlet and communicates with a central server to exchange billing information. Divx discs have the potential to ultimately replace video tapes. They're especially convenient for video rentals because there are no late fees. Once you purchase a Divx title, you never need to return it. However, Divx has thrown a monkey wrench in the DVD market because the Divx format is not backward-compatible with current DVD-ROM players. This means that you need to buy a new Divx player to play Divx titles. Understandably, people and companies who have already invested in non-Divx players are not pleased. (2) When spelled DivX, a trademark of DivXNetworks, Inc. DivX is a digital video compression format based on the MPEG-4 technology. DivX files can be downloaded over high-speed lines in a relatively short time without sacrificing the quality of the digital video.
Dongle A mechanical device used by software developers to prevent unlicensed use of their product. Typically, a Dongle is a small connector plug, supplied with the original software package, which fits into a socket on a PC—usually a parallel port, also known generally as the LPT1 Printer port. Without the Dongle present, the software will not run. Some older Dongles act as a terminator, effectively blocking the port for any other use, but later versions have a pass-through function, allowing a printer to be connected at the same time. Even though the PC can still communicate with the printer, there have been problems with more recent printers which use active two-way communications with the PC to notify printing status, ink levels, etc.
DRM Digital rights management (DRM) is the umbrella term referring to any of several technologies used to enforce pre-defined policies controlling access to software, music, movies, or other digital data and hardware. In more technical terms, DRM handles the description, layering, analysis, valuation, trading and monitoring of the rights held over a digital work. In the widest possible sense, the term refers to any such management. The term is often confused with copy protection and technical protection measures (TPM). These two terms refer to technologies that control and/or restrict the use and access of digital media content on electronic devices with such technologies installed. There are technical measures that could be used not to restrict use or access, such as to monitor use in order to record rights of a content consumer, DRM critics argue that the phrase “digital rights management” is a misnomer and the term digital restrictions management is a more accurate characterization of the functionality of DRM systems. Some digital media content publishers claim DRM technologies are necessary to prevent revenue loss due to illegal duplication of their copyrighted works. However, others argue that transferring control of the use of media from consumers to a consolidated media industry will lead to loss of existing user rights and stifle innovation in software and cultural productions.
DRM short for digital rights management. DRM is a technology that protects a piece of intellectual digital property such as a music, video, or text file. With DRM, copyrighted material downloaded from the web may be restricted so that it cannot be freely distributed.
DVD short for digital video disc, or digital versatile disc. The DVD is a second-generation CD that holds 4.7 gigabytes, or several hours of high-quality video.
Encoder a software application that converts an audio file into another format. For example, an MP3 encoder converts a wav file into an MP3 file.
FM Frequency modulation is a form of modulation which represents information as variations in the instantaneous frequency of a carrier wave. (Contrast this with amplitude modulation (AM), in which the amplitude of the carrier is varied while its frequency remains constant.) In analog applications, the carrier frequency is varied in direct proportion to changes in the amplitude of an input signal. Digital data can be represented by shifting the carrier frequency among a set of discrete values, a technique known as frequency-shift keying. FM is commonly used at VHF radio frequencies for high-fidelity broadcasts of music and speech. Normal (analog) TV sound is also broadcast using FM.
GPRS Short for General Packet Radio Service, a standard for wireless communications which runs at speeds up to 115 kilobits per second, compared with current GSM (Global System for Mobile Communications) systems' 9.6 kilobits. GPRS, which supports a wide range of bandwidths, is an efficient use of limited bandwidth and is particularly suited for sending and receiving small bursts of data, such as e-mail and Web browsing, as well as large volumes of data.
H.264 H.264, or MPEG-4 Part 10, is a high compression digital video codec standard written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding. The final drafting work on the first version of the standard was completed in May of 2003.
Hertz (Hz) the frequency of electrical vibrations (cycles) per second. One Hz is equal to one cycle per second.
Hotspot A specific geographic location in which an access point provides public wireless broadband network services to mobile visitors through a WLAN. Hotspots are often located in heavily populated places such as airports, train stations, libraries, marinas, conventions centers and hotels. Hotspots typically have a short range of access.
ID3 Digital audio files can contain, in addition to the audio track, related text and/or graphical information. The ID3 tag is a 128-byte piece of extra data (metadata), or a tag, that is added to an MP3 file (the actual location of the tag may vary) and that contains information about the file such as the name of the piece of music, the artist, the genre, and so on. This information may be displayed when playing a digital audio file on a computer or portable device. Without an ID3 tag, an MP3 would be recognizable only by the name of the file itself. ID3 tags are important to playlists because they identify pieces of music. The process of including information other than sound into these digital audio files is commonly referred to as “tagging” in which you “tag” the audio file with additional information that describes the audio file. The original standard for tagging digital files was developed in 1996 by Eric Kemp and he coined the term ID3. At that time ID3 simply meant “IDentify an MP3”. Those new to digital music may assume that only MP3 files have ID3 tags and that other audio formats (AAC, WMA, Ogg Vorbis, etc.) must therefore have some different tagging methodology. This confusion comes from ID3 being so closely associated to the MP3 audio compression format. The ID3 tagging standard gained wide acceptance because of the popularity of the MP3 file format and became the de facto standard way to tag audio files of any format. ID3 is simply a prescribed method for storing information into a file, any file, but usually an audio file.
IF An intermediate frequency (IF) is a frequency to which a carrier frequency is shifted as an intermediate step in transmission or reception. It is the beat frequency between the signal and the local oscillator in a radio detection system. IF is also the name of a stage in a super heterodyne receiver. It is where an incoming signal is amplified before final detection is done. There may be several such stages in a superhet radio receiver. Widely used IF frequencies are 10.7 MHz (FM Radio), 455 kHz (AM Radio). Other common IF frequencies are 240 MHz (Cellular/WLAN), 140 MHz (Cellular/WLAN), 70 MHz (Cellular), and various frequencies in the range 35-45 MHz (TV).
Internet A global network connecting millions of computers for the exchange of data, news and opinions. Unlike online services, which are centrally controlled, the Internet is decentralized by design. Each Internet computer, called a host, is independent. Its operators can choose which Internet services to use and which local services to make available to the global Internet community. Remarkably, this anarchy by design works exceedingly well. There are a variety of ways to access the Internet. Most online services, such as America Online, offer access to some Internet services. It is also possible to gain access through a commercial Internet Service Provider (ISP).
ISO Short for “International Organization for Standardization.” (Note that ISO is not an acronym; instead, the name derives from the Greek word iso, which means equal.)
ISO 15693 is an ISO standard for “Vicinity Cards”, i.e. cards which can be read from a greater distance as compared to Proximity cards. ISO 15693 systems operate at the 13.56 MHz frequency, and offer maximum read distance of 1-1.5 metres. An example of this being the Radio Identification tags (RFID) used to collect toll electronically these days. As the vicinity cards have to operate at a greater distance, the necessary magnetic field is less (0.15 to 5 A/m) than that for a proximity card (1.5 to 7.5 A/m).
JPEG Short for Joint Photographic Experts Group, and pronounced jay-peg. JPEG is a lossy compression technique for colour images. Although it can reduce files sizes to about 5% of their normal size, some detail is lost in the compression.
LAN Short for “Local Area Network”. A computer network that spans a relatively small area. Most LANs are confined to a single building or group of buildings. However, one LAN can be connected to other LANs over any distance via telephone lines and radio waves. A system of LANs connected in this way is called a wide-area network (WAN).
Latin A human language. Latin terms (abbreviations) may be used herein, as follows:
   cf. short for the Latin “confer”. As may be used herein, “compare”.
   e.g. short for the Latin “exempli gratia”. Also “eg” (without periods). As may be used herein, means “for example”.
   etc. short for the Latin “et cetera”. As may be used herein, means “and so forth”, or “and so on”, or “and other similar things (devices, process, as may be appropriate to the circumstances)”.
   i.e. short for the Latin “id est”. As may be used herein, “that is”.
   sic meaning “thus” or “just so”. Indicates a misspelling or error in a quoted source.
Local Oscillator A local oscillator is a device used to generate a signal which is beat against the signal of interest to mix it to a different frequency. The local oscillator produces a signal which is injected into the mixer along with the signal from the antenna in order to effectively change the antenna signal by heterodyning with it to produce the sum and difference of that signal, one of which will be at the intermediate frequency (IF) which can be handled by the IF amplifier. These are the beat frequencies. Normally the beat frequency is associated with the lower side-band, the difference between the two. Several local oscillators can be strung in series to form a local oscillator chain (LO chain).
MAC Short for media access control. Each device connected to an Ethernet network has a unique numeric identifier called a MAC address, which is used for data transmission and security functions. For instance, the MAC address lets other devices on the network find each other, and it accompanies each data packet to identify its sender.
Metadata This is literally data about data. Metadata describes useful information about a file, for example: date, time, author, running time, artist, director, etc. An ID3 tag is an example of metadata.
MP3 short for MPEG-1, audio layer 3. MP3 is a form of digital audio compression that reduces the size of audio files without drastically compromising sound quality. MP3s reduce unnecessary data that is imperceptible to the human ear. MP3 is also the name of the file extension (*.mp3) and also the name of the type of file for MPEG, audio layer 3. Layer 3 is one of three coding schemes (layer 1, layer 2 and layer 3) for the compression of audio signals. Layer 3 uses perceptual audio coding and psycho-acoustic compression to remove all superfluous information (more specifically, the redundant and irrelevant parts of a sound signal. The stuff the human ear doesn't hear anyway). It also adds a MDCT (Modified Discrete Cosine Transform) that implements a filter bank, increasing the frequency resolution 18 times higher than that of layer 2. The result in real terms is layer 3 shrinks the original sound data from a CD (with a bit rate of 1411.2 kilobits per one second of stereo music) by a factor of 12 (down to 112-128 kbps) without sacrificing sound quality.
MPEG Short for Moving Picture Experts Group, and pronounced m-peg, a working group of ISO. The term also refers to the family of digital video compression standards and file formats developed by the group. MPEG generally produces better-quality video than competing formats, such as Video for Windows, Indeo and QuickTime. MPEG files can be decoded by special hardware or by software. MPEG achieves high compression rate by storing only the changes from one frame to another, instead of each entire frame. The video information is then encoded using a technique called DCT. MPEG uses a type of lossy compression, since some data is removed. But the diminishment of data is generally imperceptible to the human eye. There are three major MPEG standards: MPEG-1, MPEG-2 and MPEG-4.
   MPEG-1 is the standard that Video CD and MP3 are based.
   MPEG-2 is the standard that digital television set top boxes and DVD are based.
   MPEG-4 is the standard for multimedia for the fixed and mobile web, which is designed to deliver DVD (MPEG-2) quality video at lower data rates and smaller file sizes.
Normalize to boost the volume of a track so that it's as loud as possible without distortion. This maximizes sound quality, eliminates noise, and produces an even volume among tracks from different sources.
NTP Short for Network Time Protocol, an Internet standard protocol (built on top of TCP/IP) that assures accurate synchronization to the millisecond of computer clock times in a network of computers. Based on UTC, NTP synchronizes client workstation clocks to the U.S. Naval Observatory Master Clocks in Washington, D.C. and Colorado Springs Co. Running as a continuous background client program on a computer, NTP sends periodic time requests to servers, obtaining server time stamps and using them to adjust the client's clock.
OGG Vorbis Ogg Vorbis is an audio compression format, comparable to other formats used to store and play digital music, but differs in that it is free, open and unpatented. The Ogg Vorbis specification is in the public domain and is freely available for commercial or non-commercial use. In Ogg Vorbis, Ogg refers to the Ogg Project which is an Open Source Multimedia initiative, while Vorbis is the actual compression format.
OLED Short for organic light-emitting diode. A display device that operates by sandwiching carbon-based films between two charged electrodes. OLED displays, originally developed by Kodak, are unlike LCDs in that they don't require backlighting; instead, they emit light themselves. OLED displays offer many advantages over LCDs, including less power consumption and brighter output, and are increasingly showing up in MP3 players and other portable devices, although TV-size displays are still in the prototype stage.
PC Short for “Personal Computer”. A PC is a single-user computer based on a microprocessor. In addition to the microprocessor, a personal computer has a keyboard for entering data, a monitor for displaying information, and a storage device for saving data.
Playlist A custom index of musical pieces that play in a certain order. A user can arrange their own playlists by artist, genre, mood, or in other ways.
PMP Short for Portable Music Player. PMP describes any digital portable music player, which allows users to download or save digital music files (in MP3 format) from their computer to play on their PMP. Some examples of a PMP would be the iPod, iRiver, Rio Karma, and the NOMAD to name a few.
PNG Short for Portable Network Graphics, and pronounced ping, a new bit-mapped graphics format similar to GIF. In fact, PNG was approved as a standard by the World Wide Web consortium to replace GIF, because GIF uses a patented data compression algorithm called LZW. In contrast, PNG is completely patent and license-free. The most recent versions of Netscape Navigator and Microsoft Internet Explorer now support PNG.
RA Short for RealAudio. The de facto standard for streaming audio data over the World Wide Web. RealAudio was developed by Real Networks and supports FM-stereo-quality sound. To hear a Web page that includes a RealAudio sound file, you need a RealAudio player or plug-in, a program that is freely available from a number of places. It's included in current versions of both Netscape Navigator and Microsoft Internet Explorer.
Ripping To extract digital audio tracks from an audio CD. A software program that extracts audio files from a CD (or video files from a DVD) is called a ripper.
SoC System-on-a-chip (SoC or SOC) is an idea of integrating all components of a computer system into a single chip. It may contain digital, analog, mixed-signal, and often radio-frequency functions—all on one chip. A typical application is in the area of embedded systems. A typical computer system consists of a number of integrated circuits that perform different tasks. These are: microprocessor, memory (RAM, ROM), UARTs, parallel ports, DMA controller chips, etc. The recent improvements in semiconductor technology have allowed VLSI integrated circuits to grow in complexity, making it possible to integrate all components of a system in a single chip. This can be done in a number of technologies. These are: Full-custom, Standard cell and FPGA. SOC designs usually consume less power and have a lower cost and higher reliability than the multi-chip systems that they replace. And with fewer packages in the system, assembly costs are obviously reduced as well.
Software Computer instructions or data. Anything that can be stored electronically is software. Software is typically stored in binary form (ones and zeros, represented by two distinctive states) on a storage medium, such as a floppy disc, hard drive, memory device, or the like, all of which may generally and broadly be referred to as “hardware”. The apparatus or system or device which responds to software instructions or manipulates software data may generally and broadly be referred to as a “computer”. Software is sometimes abbreviated as “S/W”. Software is often divided into the following two categories:
   systems software: includes the operating system and all the utilities that enable the computer to function.
   applications software: includes programs that do real work for users. For example, word processors, spreadsheets, and database management systems fall under the category of applications software.
Streaming Audio—Live audio received over the Internet without downloading it. Streaming does not save a copy of the audio on your PC, while downloading a file does. Internet radio stations generally use streaming audio to broadcast.
Superheterodyne Receiver The super heterodyne receiver (or to give it its full name, the supersonic heterodyne receiver—usually these days shortened to “superhet”) was invented by Edwin Armstrong in 1918. The super heterodyne principle, as used in radio receivers, allows certain obstacles in high performance radio design to be overcome. Tuned radio frequency (TRF) receivers suffered from poor frequency stability, and poor selectivity, as even filters with a high Q factor have a wide bandwidth at radio frequencies. Regenerative and super-regenerative receivers offer better sensitivity but suffer from stability and selectivity problems. In radios using the principle, all signal frequencies are converted typically to a constant lower frequency before detection. This constant frequency is called the intermediate frequency, or IF. In typical AM (Medium Wave) home receivers, that frequency is 455 kHz, for FM VHF receivers, it is usually 10.7 MHz. Heterodyne receivers “beat” or heterodyne a frequency from a local oscillator (within the receiver) with all the incoming signals. The user tunes the radio by adjusting the set's oscillator frequency. In a mixer stage of the receiver, the local oscillator signal multiplies with the incoming signal, producing beat frequencies both above and below the incoming signal. The mixer stage produces outputs at both the sum of the two input frequencies and at the difference. Either the higher or the lower (typically) is chosen as the IF, which is amplified and then demodulated (reduced to just audio frequencies through a speaker). Almost all receivers in use today utilize this method. In practice not every design will have all these elements as described above, nor does this convey the complexity of other designs, but the essential elements of a local oscillator and a mixer followed by a filter and IF amplifier are common to all superhet circuits. Cost-optimized designs may use one active device for both local oscillator and mixer—this is sometimes called a “converter” stage. Generally, the signal from the antenna is first amplified (RF Amplifier), then is passed to a mixer which also receives a signal from the local oscillator, the mixer is followed by a filter then an IF amplifier, then to the demodulator and audio amplifier. The advantage to this method is that most of the radio's signal path has to be sensitive to only a narrow range of frequencies. Only the front end (the part before the frequency converter stage) needs to be sensitive to a wide frequency range. For example, the front end might need to be sensitive to 1-30 MHz, while the rest of the radio might need to be sensitive only to 455 kHz, a typical IF frequency. Sometimes, to overcome obstacles such as image response, more than one IF is used. In such a case, the front end might be sensitive to 1-30 MHz, the first half of the radio to 5 MHz, and the last half to 50 kHz. Two frequency converters would be used, and the radio would be a “Double Conversion Super Heterodyne”—a common example is a television receiver where the audio information is obtained from a second stage of intermediate frequency conversion. Occasionally special-purpose receivers will use an intermediate frequency much higher than the signal, in order to obtain very high image rejection. Super Heterodyne receivers have superior characteristics to simpler receiver types in frequency stability and selectivity. It is much easier to stabilize an oscillator than a filter, especially with modern frequency synthesizer technology, and IF filters can give much narrower passbands at the same Q factor than an equivalent RF filter. A fixed IF also allows the use of a crystal filter in very critical designs such as radiotelephone receivers which have exceptionally high selectivity. Radio transmitters may also use a mixer stage to produce an output frequency. The next evolution of Super Heterodyne receiver design is the software defined radio architecture, where the IF processing after the initial IF filter is implemented in software.
TCP/IP Short for “Transmission Control Protocol/Internet Protocol”. TCP/IP has become the basic protocol that defines how information is exchanged over the Internet. IP software sets the rules for data transfer over a network, while TCP software ensures the safe and reliable transfer of data. The abbreviation TCP/IP is commonly used to represent the whole suite of internetworking software.
TFT Short for thin film transistor, a type of LCD flat-panel display screen, in which each pixel is controlled by one to four transistors. The TFT technology provides the best resolution of all the flat-panel techniques, but it is also the most expensive. TFT screens are sometimes called active-matrix LCDs.
Track on an audio CD, a track is a single section of audio (typically a single song or piece of music) that you can jump to immediately.
UTC Coordinated Universal Time (UTC) is a time scale that couples Greenwich Mean Time, which is based solely on the Earth's inconsistent rotation rate, with highly accurate atomic time. When atomic time and Earth time approach a one second difference, a leap second is calculated into UTC. UTC was devised on Jan. 1, 1972 and is coordinated in Paris by the International Bureau of Weights and Measures. UTC, like Greenwich Mean Time, is set at 0 degrees longitude on the prime meridian.
VBR Short for variable bit rate. VBR specifies the sound quality level but allows the bit rate to fluctuate. During complex passages, VBR uses a higher-than-average bit rate but during simple passages uses a lower-than-average bit rate. The result is that VBR produces an overall higher, more consistent sound quality compared to CBR (constant bit rate) at similar bit rates. VBR allows users to specify a throughput capacity (i.e., a peak rate) and a sustained rate but data is not sent evenly. VBR is often used when transmitting compressed packetized voice and video data, such as videoconferencing.
VoD Short for Video-on-Demand, an umbrella term for a wide set of technologies and companies whose common goal is to enable individuals to select videos from a central server for viewing on a television or computer screen. VoD can be used for entertainment (ordering movies transmitted digitally), education (viewing training videos), and video conferencing (enhancing presentations with video clips). Although VoD is being used somewhat in all these areas, it is not yet widely implemented. VoD's biggest obstacle is the lack of a network infrastructure that can handle the large amounts of data required by video.
WAV A standard format for digital sound, developed by Microsoft. WAV files produce extremely high sound quality but generally take up more space than MP3s. A typical 3 minute song stored in .wav format may require approximately 30 megabytes, and the same song in MP3 format may require approximately 3 megabytes.
Web-cast An Internet term. A web-cast is essentially the Internet version of a radio broadcast.
Wi-Fi Short for wireless fidelity and is meant to be used generically when referring to any type of 802.11 network, whether 802.11b, 802.11a, dual-band, etc. The term is promulgated by the Wi-Fi Alliance. Any products tested and approved as “Wi-Fi Certified” (a registered trademark) by the Wi-Fi Alliance are certified as interoperable with each other, even if they are from different manufacturers. A user with a “Wi-Fi Certified” product can use any brand of access point with any other brand of client hardware that also is certified. Typically, however, any Wi-Fi product using the same radio frequency (for example, 2.4 GHz for 802.11b or 11 g, 5 GHz for 802.11a) will work with any other, even if not “Wi-Fi Certified.” Formerly, the term “Wi-Fi” was used only in place of the 2.4 GHz 802.11b standard, in the same way that “Ethernet” is used in place of IEEE 802.3. The Alliance expanded the generic use of the term in an attempt to stop confusion about wireless LAN interoperability.
WiMax The name commonly given to the IEEE 802.16 wireless standard.
WMA Short for Windows Media Audio, a Microsoft file format for encoding digital audio files similar to MP3, though can compress files at a higher rate than MP3. WMA files, which use the “.wma” file extension, can be of any size compressed to match many different connection speeds, or bandwidths. WMA offers near-CD-quality sound at an encoding rate of only 64 kbps (as opposed to MP3's 128 kbps), cutting the file size in half. Optional copyright protection is included in the wma code, allowing the owner to restrict the use of protected material.
Zigbee The ZigBee specification is a combination of HomeRF Lite and the 802.15.4 specification. The spec operates in the 2.4 GHz (ISM) radio band—the same band as 802.11b standard, Bluetooth, microwaves and some other devices. It is capable of connecting 255 devices per network. The specification supports data transmission rates of up to 250 Kbps at a range of up to 30 meters. ZigBee's technology is slower than 802.11b (11 Mbps) and Bluetooth (1 Mbps), but it consumes significantly less power.

### BRIEF DESCRIPTION (SUMMARY)

Generally, a portable music device (PMD) comprises means for enabling a user to capture song tags as he is listening to (monitoring) a broadcast (via Internet or radio), either on the PMD (via a connection to the Internet), or on the PMD (via a built-in FM radio receiver), or on a nearby radio (by detecting the station to which the nearby radio is tuned). The user can later use the song tags which he has captured to download song files (songs) from a music vendor, either on the Internet or in a physical music shop. The song tags may comprise an ID3-type tag which has been modified to include a link to a web address (www) of a server for downloading the desired songs.

When the user uploads the captured (saved) song tag to the server, the server can then download the song file to the user. Payment schemes can also be implemented using credits from the server downloading the song file to the user, or from other sources of electronic credits which may be stored in the PMD. The user can also download songs at a physical music store using a wireless interface (such as Bluetooth) in the PMD to download the song file (typically in MP3 format) and a contactless interface (using a smart card protocol) in the PMD to pay for the downloaded song.

According to an embodiment of the invention, a portable wireless Internet radio apparatus comprises: an interface selected from the group consisting of wireless interface, contactless interface and mechanical connection interface for interfacing to an Internet-capable appliance which provides access to the Internet; and means for capturing song tags. The apparatus may further comprise a FM receiver for receiving FM radio broadcasts, an RF detector for determining the frequency to which a nearby receiver is tuned and/or an FM transmitter for transmitting to a nearby FM receiver.

According to an embodiment of the invention, a method of downloading songs from the Internet, comprises: capturing tags of songs of interest to a user; and subsequently connecting to the Internet and downloading files for the songs of interest based on the captured tags.

According to an embodiment of the invention, a personal music device (PMD) comprises: means for capturing tags of songs of interest to a user; and means for connecting to the Internet and downloading files for the songs of interest based on the captured tags.

According to an embodiment of the invention, an enhanced song tag comprises: an ID3 tag; and a web address linking to a server for downloading songs.

Other objects, features and advantages of the invention will become apparent in light of the following description(s) thereof.

### BRIEF DESCRIPTION OF THE DRAWINGS

The structure, operation, and advantages of the present preferred embodiment of the invention will become further apparent upon consideration of the descriptions set forth herein, taken in conjunction with the accompanying figures (FIGs). The figures (FIGs) are intended to be illustrative, not limiting. Although the invention is generally described in the context of these preferred embodiments, it should be understood that it is not intended to limit the spirit and scope of the invention to these particular embodiments.

FIG. 1 is a diagram of an environment in which a personal music device (PMD) is capable of operating and interacting, according to the invention.

FIG. 2 is a diagram of major functional blocks of a personal music device (PMD), according to the invention.

FIG. 3 is a diagram of a physical embodiment of a personal music device (PMD), according to the invention.

FIG. 4 is a diagram of the personal music device (PMD), of FIG. 3, in a docking station.

### DETAILED DESCRIPTION OF THE INVENTION

The invention is generally directed to a personal music device (PMD), which can be considered to be a type of or extension of a personal music player (PMP).

The PMD allows a user to listen to music (songs) provided by Internet radio stations (typically in a streaming format) or conventional broadcast stations (typically FM radio stations), with a Capture Tune™ feature allowing the user to select (for later downloading) music from any radio station in the world that streams through the World Wide Web. Other features and capabilities are included.

A user listening to Internet radio (such as in a Wi-Fi hotspot) can select songs as they are being played, by simply pressing a “song capture” button on the apparatus, and simultaneously or later downloading the song (in any suitable file format) from the website of the music station to the PMD apparatus.

The audio format of each song being broadcast is typically encoded with the name of the song (artists, album, genre, year, title) and the website address linking to the server of the Internet radio station, or to a website associated with the broadcast radio station.

The process of tagging digital audio files with information such as the name of the song (artists, album, genre, year, title) is commonly known as ID3 tagging. According to a feature of the invention, a chunk of extra data is added to the tag file to include the website address & song location linking to the server of the Internet (or broadcast) radio station. Alternatively, the website address & song location could reside inside the audio file. The website address and song location is then saved in the digital file between the audio and the ID3 tag.

The PMD apparatus can also support subscription services allowing the user to subscribe to a streaming audio service that provides programs on line.

The PMD apparatus has a built-in FM (Frequency Modulation) tuner for listening to local FM radio stations, and a FM transmitter to broadcast downloaded (or stored) songs to a car radio or the FM radio of any entertainment system.

The PMD apparatus can detect or scan the frequency at which an external radio receiver (car radio, or radio of an entertainment system) is tuned to, by picking up the signals radiated by the internal local oscillator of the external radio receiver. The apparatus locks onto the same radio station as the external radio receiver and allows the listener, as with Internet radio, to select tagged songs as they are being played by pressing the song capture button and then downloading the selected song, without having to know the name of the song, from the website of the Internet (or broadcast) radio station.

When in a wireless network or communicating with an Internet connected PC, the PMD apparatus can synchronize itself with an Internet Atomic Clock (public NTP server), allowing every download & transaction to be recorded with an exact time/date stamp. This makes it possible to have a time-out function on rented songs or content, even if the music or content has been shared or exchanged with other individuals.

The PMD apparatus may be provided with communication interfaces including, but not limited to, Wi-Fi, Radio Frequency Identification (RFID), Zigbee, NFC, Bluetooth, Ultra Wide Band (UWB), and Infra Red (IR).

The PMD apparatus may have an insertion slot to accommodate a smart card (contact & contactless) or keychain fob for online payment purposes, authentication and identification. In addition, the PMD apparatus can incorporate Compact flash or SDIO slots for removable memory storage.

In addition, the PMD apparatus may have an insertion slot for a multiple interface USB dongle or token which can interface with a PC, have an electronic purse and communicate in contactless mode with a RFID reader in a real world application.

Music lovers can select preferred new releases as they are being broadcasted over the radio waves or streamed over the World Wide Web and download them from the radio station, enabling the station or music labels to ascertain or rank which artist was most popular in the music charts.

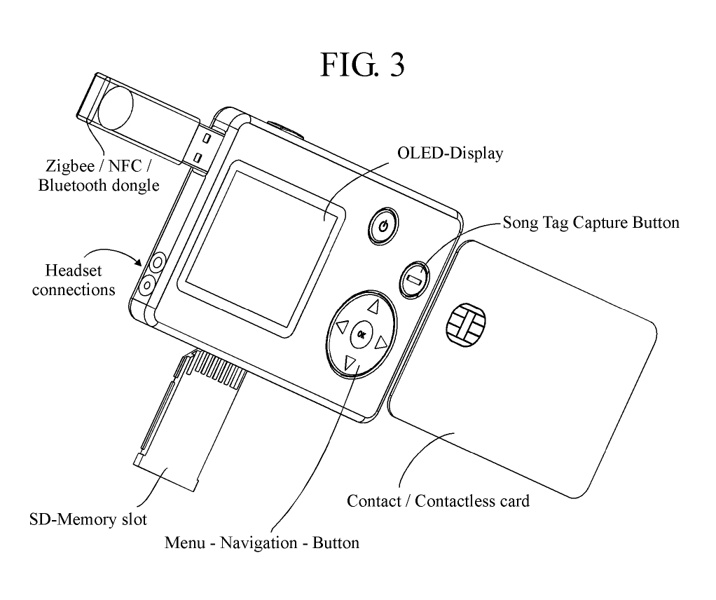

The PMD apparatus may resemble a conventional USB memory fob (or card) in size, shape and form, which can stream all global stations in a wireless hotspot. Or; it may resemble a hand-held computing device such as a PDA, such as illustrated in FIG. 3.

The apparatus allows the user to listen to any Internet radio station that web-casts in MP3, WMA, RealAudio or Vorbis audio format. The PMD apparatus can record a broadcast directly from the Internet and the recording can be played back at the user's convenience using stereo headphones/earpieces, or via a Bluetooth audio adapter/headset. Alternatively, the audio recording can be transmitted from the PMD apparatus to a car radio or to the radio of an entertainment system. The PMD apparatus also has a built-in FM tuner for listening to local FM radio stations. In addition, the PMD apparatus can support wireless Internet radio subscription services using a unique identification number.

Internet radio can also be accessed using broadband cable connection directly to the PMD apparatus.

Other features of the PMD apparatus include microphone (for commentary, memo recording, karaoke singing), timer recording, MP3 player, OLED display for News/Sport/Weather ticker-tape banner and station selection mechanism. Media storage can be flash memory and or HDD. Additional communication interfaces to the Wi-Fi include Radio Frequency Identification, Zigbee, NFC, Bluetooth, Ultra Wide Band, and Infra Red.

Hotspot zones with Internet connection via wireless LAN include airplanes, airports, cruise ships, gyms, hotels, Internet cafés, parks, passenger trains, public buildings (convention centers, hospitals, libraries, sport facilities, universities, etc), shopping malls and tour buses.

In non-interrupt Internet music stations, it will be possible to record and buy individual songs outright for a small fee. Alternatively, renting songs to users who pay a monthly subscription fee will also be possible. Recently, Yahoo (Yahoo Music Unlimited) and Real Networks (Rhapsody) have introduced a subscription service for the legal online music market, giving the user the right to download rented songs for a certain period of time and to transfer them to any compatible music player. This “jukebox” program service can also apply for Internet Radio, by allowing users to download music, decide on a compilation of song titles and then to order the original songs in any format from the Internet Music Station, using the payment vehicle in the apparatus. A time-out function for rented songs can apply.

After songs have been downloaded, the user can share & exchange songs with other individuals by transmitting via a wireless interface (802.11) or any suitable interface such as Zigbee, Near Field Communication (NFC), Bluetooth, Ultra Wide Band (UWB), and similar interfaces.

The PMD apparatus supports Digital Rights Management (DRM) for playback of copyright music, by limiting the exchange of songs to a maximum number.

The apparatus is an interactive travel entertainment device for people “on the go”.

The billing method during the downloading of songs can be via a smart card interface (prepaid or credit), on a subscription or on a rental basis.

Under the subscription method, the user pays a monthly fee (flat rate) similar in concept to a mobile telephone charge. And the more songs that are downloaded, the higher the bill.

Alternatively, the user can rent songs for a certain period with automatic reminder of expiration.

Using the contactless interface, the user can transfer electronic cash to other individuals and the apparatus can be used for identification in a music store.

A Portable Wireless Digital Entertainment Apparatus in Card Format

The PMD apparatus is provided with multiple interfaces, which can stream digital media content from an Internet access point (AP) to the PMD apparatus wirelessly or via a fast Ethernet cable. The apparatus gives the user the ability to connect to a wireless network at home, at the office or at any wireless hotspot (airports, coffee shops, shopping centers & malls, sporting venues, university, etc).

The user can navigate through the content being streamed from the World Wide Web or from an Internet Portal Provider.

In the retailer environment, the wireless network is constantly polling the airwaves looking for individuals with such an apparatus and thus participating merchants or service providers can communicate sales and discount promotions and other offers relevant to the consumer's preference.

As the apparatus is interactive, the user can select or reject content and can also share and exchange content with others.

The apparatus can also support VoD (Video on Demand) in high speed networks.

A decoder chip and digital signal processor (DSP) in the PMD apparatus restore the compressed music files to their original sound—strong at low frequency, clear and loud at high frequency. Using the wireless interface, the user can share and exchange JPEG images and MP3 files.

The PMD apparatus for streaming (content) audio and video signals combines, for example, the function of a MP3 jukebox, Multimedia receiver, a digital photo album, a voice recorder, FM tuner and Java applications.

The PMD apparatus has multiple interfaces and incorporates flash memory or hard disk drive for mass storage and playback as well as a Compact flash card slot for removable memory storage. Transfer/copy file content from the compact flash card to the hard disk drive and vice-versa are possible.

With 100 gigabyte HDD capacity, the PMD apparatus can be used as a storage unit for up to 25,000 songs (Music collection), 200,000 photos or more than 100 hours of video.

Various multimedia formats include; Audio Decoding Formats: AAC/AC-3 (Dolby Digital)/ADPCM/MP3/MP3 VBR/OGG Vorbis/WAV WMA/WMA-DRM/Apple (iPod), Video Formats: MPEG 1, 2 & 4 (DivX/AVI) and Photo Formats: JPEG and PNG. Media Streaming Modulation is Wi-Fi 802.11g & n environment and downloadable firmware updates can be accessed from the Internet.

The PMD apparatus has a TFT LCD screen or OLED display showing HDD/Card/battery capacity, file & folder browser, battery charging status, and operating status. The apparatus can also include a digital clock & alarm as well as a calculator.

The dimensions of the PMD apparatus in card format may be approximately 112 mm (L)×70 mm (W)×9.7 mm (H). A compact version of the PMD apparatus could have the dimensions 80 mm (L)×60 mm (W)×20 mm (H).

Music Download from an Internet Radio Station

As already described above, the user can use the PMD apparatus to download songs from the website of the Internet radio station, or broadcast radio station.

The principle of tagging an audio digital file with information relating to the website of the radio station can also be applied to satellite radios which decode the encrypted digital signal (audio and data streams) from the satellites and repeaters.

Digital Rights Management with Time-Out Function

When in a wireless hotspot or communicating with an Internet connected PC, the apparatus can synchronize itself with an Internet Atomic Clock (public NTP server), allowing every download & transaction to be recorded with an exact time/date stamp.

Using this exact time synchronization method, it is possible to attach a time-out on the use of a music or content download. The technique can also be used for licensing purposes and to limit the number of devices that may be played on.

AM/FM Radio Scanner and Music Tag Storage Apparatus

Many people listen to the radio while traveling in their automobile. The radio updates them on the latest news events and they connect with their favorite radio personality as they listen to new music or their favorite “oldies”. The inside of the automobile, with the latest in surround sound becomes their personal private concert hall.

But even with all the latest in mobile audio technology, there is no easy way to store and then retrieve the name (unique identification) of a song heard while traveling in an automobile. Many radio stations are capable of broadcasting their call letters and frequency, as a separate information track that scrolls across the car radio display. Additionally, many of those same stations will also broadcast the name of the song & the artist currently on the air. This information is of little value to a lone driver, as it is neither safe nor practical to write the song title on a note pad while traveling at freeway speeds.

Also, many older vehicles are not equipped with radios capable of receiving these additional information or tag broadcasts.

The PMD apparatus may be carried on a key ring or can be mounted to the dashboard or console of a car, and in general terms comprises an AM/FM radio scanner, processor/memory, membrane switch input device, a small LCD display, LED's, USB and Bluetooth circuit to connect to a personal computer or Bluetooth enabled cell phone/MP3 phone.

When the PMD apparatus is in close proximity to a radio (car radio for example, but it will operate with any radio) the frequency scanner will lock on to the current frequency (radio station) that the radio is tuned to and if the radio station is broadcasting a tag containing the song title, the user will have the opportunity to capture and store this tag by simply pushing the “song capture” button on the apparatus. The apparatus will also simultaneously capture the time (date stamp) and the frequency—radio station call letters. When a new radio station is selected the apparatus once again locks onto that signal and is ready to capture & store song tags.

Radio Station Frequency Detection

Conventional AM/FM radios heterodyne a frequency from the internal local oscillator with all the incoming signals. By tuning the radio to a particular station the user adjusts the radio's oscillator frequency. In the mixer stage of the radio receiver, the local oscillator signal multiplies with the incoming signal, producing beat frequencies both above and below the incoming signal. The mixer stage produces outputs at both the sum of the two input frequencies and at the difference. Either the higher or the lower is chosen as the intermediate frequency (IF is 10.7 MHz for a FM receiver using the standard 88- to 108 MHz band), which is amplified and then demodulated to audio frequencies.

The apparatus can pick-up the frequency of the local oscillator & shift in the carrier frequency (Intermediate Frequency) when tuned to a certain radio station. As the local oscillator radiates the signal back through the antenna, it is possible to ascertain at what frequency the apparatus is tuned to.

When the user reaches his destination the PMD apparatus can be connected to a computer (PC), such as via a USB port or by Bluetooth. Software installed on the computer recognizes the apparatus and opens the application. The application will poll the apparatus, transferring the stored song tags to the application on the PC. The user can then connect to his favorite music download site and purchase the selected songs.

Radio stations may elect to give the apparatus away to listeners as a way to promote their station(s) and their music download website. A custom application would allow a user to link the apparatus directly to the stations music download site.

When the user connects the apparatus to his PC and transfers the stored tags to his desktop or MP3/phone the time/date stamp, call letters and artist/song titles are uploaded to a server. This information can be valuable to radio stations in determining accurate listener profiles and give the stations sales team important data when selling the station to potential advertisers.

The consent for this information upload can be buried in the terms & conditions the user will need to accept before the desktop software application will install.

Portable USB Apparatus with FM/AM/Short-Wave Scanner

(RF Detector for Identifying the Frequency, at Which an External Radio Receiver is Tuned)

The PMD apparatus locks to the tuned radio station of an external radio such as a car radio, allowing the user to select tagged songs as they are being played, by activating a push button to store the individual tag (and/or other digital information being broadcast along with the song). The selected songs may then be downloaded in CD quality from the server of the radio station or via a third party server. The PMD apparatus has a unique MAC address as well as an embedded link to a server. As the radio station transmits an identifier code and the songs are tagged, it is feasible to store this data on a portable USB fob. When the apparatus is in sync with the external radio, it releases a beep signal. Songs can be downloaded, for example in MP3 format, to a limited number of computing or jukebox devices in the possession of the user.

Portable FM/AM/Short-Wave Receiver with USB Plug, Memory Storage, Display and Song Selection Button

As also described above, the user selects their favorite songs as they are being played on the radio station and then downloads the exact song at their own convenience from an Internet connected PC linking to the radio station server, without having to memorize the name of the song or artist.

In a further application of the PMD apparatus, it can be used to entice users to download songs as described by providing them with the chance of winning a gift, lottery or sweep ticket. The radio station can further motivate advertising companies to participate in their promotion campaigns. The apparatus can automatically select those radio stations that transmit songs with tags.

FM/AM/Short-Wave Car Radio with XM Satellite Reception—with Display, Song Selection Button and Bluetooth Interface

An XM radio can receive and play XM's encrypted digital signal once that radio is activated. As each XM radio comes with an information display screen that shows the channel name and number, artist, and song title, it is possible to store this data after a song has been selected and transmitted to a Bluetooth enabled fob with memory storage for downloading in highest quality from the radio station's server or from XM Satellite Radio.

Portable MP3 Player with FM/AM/Short-Wave Radio Receiver with Song Selection Button

MP3 Enabled Phones with Bluetooth Interface for Downloading Selected Songs Using a Mobile Handset

Digital Audio Broadcasting (DAB), Digital Video Broadcasting (DVB) or Digital Multi-Media Broadcasting (DMB) with a Video or Audio Selection Button to Store Tags

Like music selection the user can select a video and download at their convenience the file (compressed) from the broadcasting station.

FM Transceiver with Song Tag Capture Feature (Button & Storage)

The following embodiment is an alternative method to capturing song tags from broadcasted music being played on a standard radio.

In this embodiment of the PMD apparatus, the user selects their preferred radio station on the PMD apparatus, which in turn transmits the selected station to a non-interference channel on the car radio or any FM radio. As music is being played the user can select songs by activating a button on the PMD apparatus. The user can download the selected songs in any music format at their convenience from the online provider. The apparatus can also store the songs for example in MP3 format file and can be played back via transmission to the car radio.

The low power FM signal sufficient to transmit from the PMD apparatus to a car radio, from within the car, on the FM band, is believed to not require a license. The concept of transmitting from the PMD apparatus to a radio include to the radio of a home entertainment center, or the like. Alternatively, the PMD apparatus can transmit via Bluetooth, or the like, to a Bluetooth enabled radio, entertainment center, PC, or the like.

The PMD apparatus can have an internal rechargeable battery or can be powered from a car cigarette power outlet.

This Capture Tunes™ mechanism can support music from subscription services and the restrictions imposed by digital-rights management.

In another embodiment of the PMD apparatus, the user can listen to Internet radio whilst in a Wi-Fi area or hotspot and select tagged music or audio books as they are being streamed.

Remote Control USB Token with Song Tag Capture Button for a Wi-Fi Audio Player

Working on the same principle of catching tagged tunes as they are being played on Internet Radio, a remote control apparatus can store the selected tagged songs for online-download.

Capture Tunes™ product and service

The PMD apparatus described hereinabove is a portable device with a song tag capture button & memory storage which can be a FM radio, Internet radio or a USB token which can communicate with another radio apparatus at a remote distance via one or several communication interfaces such as Zigbee, NFC, Bluetooth, Infrared, etc. The PMD apparatus has a USB plug for insertion into the port of an Internet connected PC. By pressing the song tag capture button on the apparatus during the broadcast or streaming of a music piece, the apparatus stores the music tag, allowing the user to download, at their convenience, the selected music from the radio station server to their own PC.

Generally, when the user is monitoring or listening to songs (whether on the PMD apparatus directly (via internal FM receiver), or indirectly (via an Internet connection), or on a nearby radio), and the user determines that he would like to mark the song as a candidate for subsequent downloading (at the user's convenience, when connected to the Internet (from an Internet music vendor) or at a real world vendor (physical music store) the song tag (including with enhancements, as described herein) is stored. Depending on the broadcasting and listening environment, either normal tags or enhanced tags can be captured.

In order to make this feature practical, the PMD apparatus may capture every song tag in temporary memory, thereby permitting the user to either mark the current song as a candidate for subsequent downloading, or navigate through the last few song tags in temporary memory to mark selected previous songs for subsequent downloading. For example, when the user presses the song tag capture button (see FIG. 3), the (enhanced) tag is stored for later downloading.

The user can record songs directly from broadcast FM radio or Internet radio with no DJs & no commercials, and then save them as MP3, WAV, WMA, AAC (ipod) or any audio format. In the recording process the music tags for each selected song are stored, allowing the user to download their favourites in CD quality from the radio station or any third party server. The user can then export them to a digital music player/Jukebox or a medium (such as SD Card) so as to keep a personal archive of their collection.

Music lovers can select preferred new releases as they are being broadcasted over the radio waves or streamed over the World Wide Web and download them from the radio station, enabling the station or music labels to ascertain or rank which artist was most popular in the music charts.

Portable Internet Radio

A portable Internet radio device (apparatus), which can stream all global stations in a wireless network and having a capture tune mechanism to allow a listener to select tagged music for downloading in CD quality.

The digital tags are not only encoded with the name of the song and artist but with the website address linking to the server of the Internet radio station. After songs have been downloaded for purchase or rental, the user can share and exchange songs with other individuals with a time out function on certain transactions. As the apparatus can synchronize itself with an Internet (atomic) clock, every download can be recorded with an exact time/date stamp.

In addition to Internet radio receiving capability, the apparatus has a FM receiver, transmitter and can also lock itself onto the tuned frequency of a nearby receiver.

Music lovers can select preferred new releases as they are being broadcasted over the radio waves or streamed over the Internet and download them from the radio station, enabling the station or music labels to ascertain or rank which artist was most popular in the music charts.

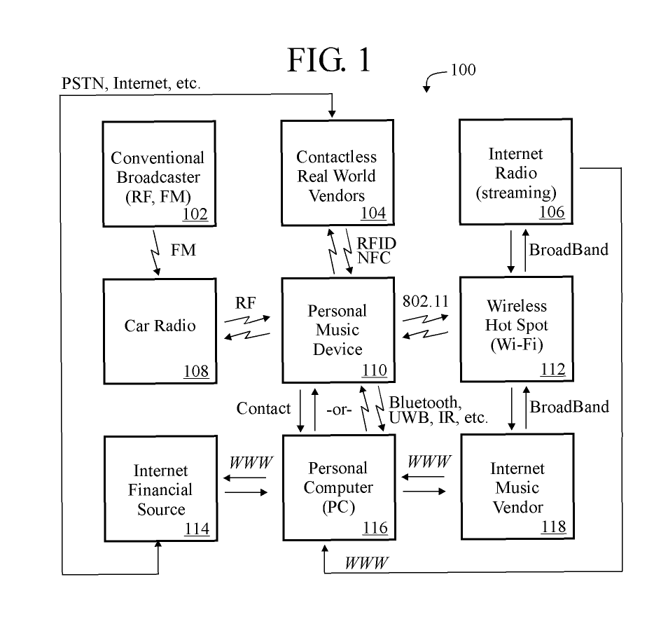

FIG. 1 illustrates an overall environment 100 in which a personal music device (PMD) 110 is capable of operating and interacting with other entities and devices in the environment, using various communications links.

The PMD 110 can communicate with a personal computer (PC) 116 over a contact interface such as USB and/or over a wireless interface such as Zigbee, Bluetooth, UWB, IR, and other similar wireless interfaces. The PC 116 can interact with the PMD 110 to receive data from the PMD and to send data to the PMD 110. The PC 116 is an Internet-capable appliance which provides access to the Internet (WWW) for the PMD 110. The PC 116 gains access to the Internet via a TCP/IP link, such as telephone modem, ADSL, and other similar TCP/IP links.

The PMD 110 is a portable device and, as such, can be used to gain access to the Internet over a wireless interface such as IEEE 802.11 in a wireless (Wi-Fi) hot spot 112, such as an Internet cafe. The wireless hot spot 112 would typically have broadband access to the Internet via a TCP/IP link, such as telephone modem, ADSL, and other similar TCP/IP links.

With Internet access (WWW), the PMD 110 can interact with an Internet Music Vendor 118, either via the user's PC 116 or via the wireless hot spot 112.

With Internet access (WWW), the PMD 110 can also interact with an Internet Financial Source 114, such as to conduct financial transactions (uploading or downloading credits). The Internet Financial Source 114 may communicate with Real World Vendors 104 such as a department store, over a direct modem link (not described hereinabove) using the public switched telephone network (PSTN), or via a TCP/IP link using the Internet to conduct their financial transactions with one another.

For example, the user downloads credits onto his PMD apparatus from the Internet Financial Source 114 and at the Real World Vendor can interact via the PMD's contactless interface to purchase items using his downloaded credits.

For example, the user downloads credits onto his PMD apparatus from the Internet Financial Source 114 and can download songs from the Internet music vendor 118 using his downloaded credits.

The PMD 110 has its own FM radio receiver for receiving FM broadcasts, and a Capture Tune™ feature for selecting songs for downloading.

The PMD 110 can also interact with a car radio using a radio (RF) interface for the purpose of:

1. determining and locking onto the frequency to which the car radio is tuned (as described elsewhere in this document); and

2. transmitting to the car radio (as described elsewhere in this document).

The Car Radio 108 (or any radio such as in the user's home or office) receives broadcasts from a conventional radio broadcaster 102 via a radio interface, such as FM.

The conventional radio broadcaster 102 may be associated with the Internet Music Vendor 118.

The PMD 110 can also tune into webcasts provided by an Internet Radio provider 106 via his PC 116 or via the wireless hotspot 112, and use the PMD's Capture Tune™ feature for selecting songs for downloading.

The Internet Radio provider 106 may simply be the Internet presence of the conventional radio broadcaster 102.

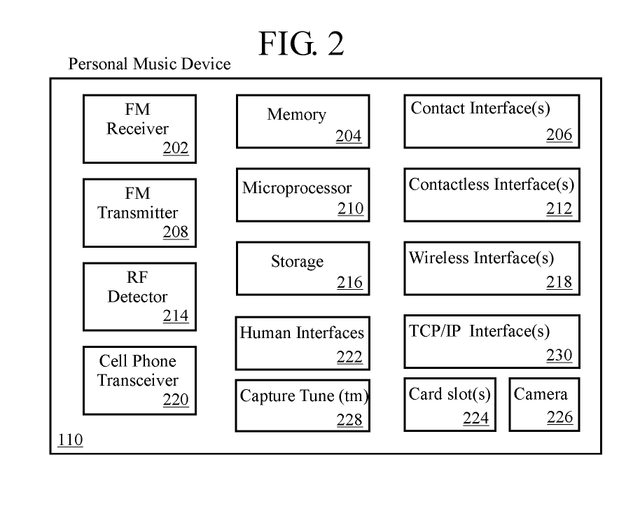

FIG. 2 illustrates major functional blocks of the personal music device (PMD) 110, including:

an FM receiver 202 for listening to broadcast radio stations.

memory 204

contact interfaces 206, such as (but not limited to) USB

an FM transmitter 208 for transmitting to an external FM radio, such as (but not limited to) a car radio

a microprocessor 210 for controlling the operation of the other functional blocks

contactless interfaces 212, such as (but not limited to) ISO 14443, ISO 15693 and NFC

an RF detector 214 for sensing what station an external radio is tuned to

storage 216, such as (but not limited to) a hard drive (HDD)

wireless interfaces 218, such as (but not limited to) IEEE 802.11

a cell phone transceiver 220, for functioning as a cell phone

human interfaces 222, such as (but not limited to) display, keyboard, switches, microphone, headphone

a card slot 224 for inserting SD cards, and the like

a camera 226, for taking pictures and recording video

a Capture Tune™ feature 228 including software for capturing song tags, and including a button designated for capturing song tags

TCP/IP interface(s) 230 for communicating via networks, such as (but not limited to) the Internet.

Storage 216 may be an internal flash drive or an HDD augmented by external memory such as a removable SD memory stick. (Memory 204 may be standard RAM for the microprocessor 210.) The FM receiver 202 is the standard FM radio. The RF Detector 208 is the tuned frequency detection. For transmitting to a standard FM radio, FM transmitter 208. The Cell Phone Transceiver 220 means you can get into the GSM or 3G network to stream the Web and download music or content to the apparatus, as well as to make standard cell phone calls.

FIG. 3 illustrates a possible physical format for the PMD, having:

a housing for the internal electronics/components (such as described in FIG. 2)

a socket for receiving RFID/Zigbee/NFC/Bluetooth dongle

socket(s) for headset (earphone, microphone) connections

slot for receiving external memory, such as SD card

menu/navigation button

on/off switch

song tag capture button (Capture Tune™ feature)

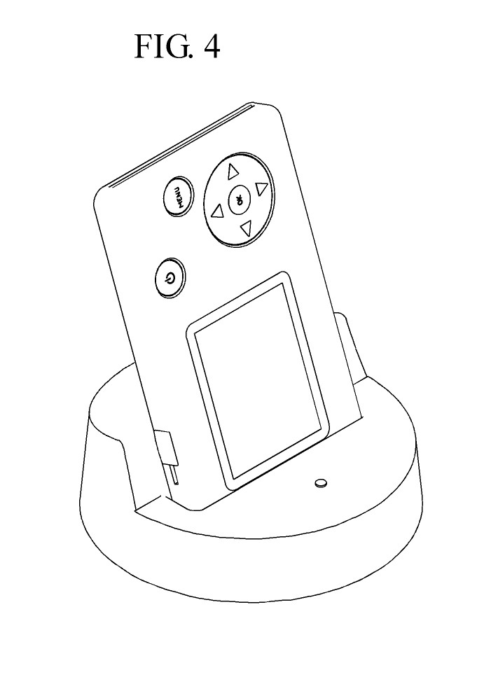

FIG. 4 illustrates the PMD in a docking station, such as for recharging.

Features of the Personal Music Device (PMD)

The invention is directed to a personal (portable) music device (PMD) having one or more, including all of, the following features (capabilities):

Contact module, for connecting to an Internet capable appliance (such as a Personal Computer)

for interacting with the PC

for tuning to Internet radio stations

For example, the contact module can be a mechanical connection such as a USB plug for insertion into a port of an Internet connected PC.

Wireless module (Wi-Fi enabled) to connect to the Internet, when in a hotspot

for tuning to Internet radio stations

For example, when in a Wi-Fi hotspot or wireless network the apparatus can stream radio content over the Web.

Contactless module, for performing transactions in the real world.

For example, a contactless interface could be used for micro-payment. By inserting a contactless fob loaded with e-money into a slot in the apparatus and when the user selects songs for downloading, the amount payable can be deducted from the debit amount in memory of the fob. In addition to payment, the contactless fob and apparatus could be used in a music store for identification as a member and to conduct transactions.

RF receiver, for tuning (receiving) to FM broadcast stations

and capability of capturing ID3 tags (metatags associated with the MP3 music format)

For example, the apparatus may include a conventional FM radio and broadcasted music can be selected (for later downloading). In essence, the user does not need to know the name of the song, he merely captures the tag (such as an ID3 tag) containing the information relating to the song and the website address of the radio station. Most FM radios are digital, and songs can be transmitted with a tag.

RF Detector, for determining local oscillator frequency of nearby radio receiver

then, can tune to the same frequency and capture ID3 tags

For example, by placing the apparatus on the dashboard or console of a motor vehicle, it can pick up the leakage signal from the local oscillator in the car radio, which indicates what frequency the car radio is tuned to. Thereafter, the user can capture the tag (such as an ID3 tag) containing the information relating to the song and the website address of the radio station.

RF transmitter, for transmitting to an FM receiver (such as in a car)

such as songs stored on the PMD

For example, after songs have been downloaded to the memory of the apparatus (flash memory or hard disk drive) or to a removable SD memory stick (insertable into a slot in the apparatus), the user can play back the music on a non-interference channel (FM) on the car radio set.

Capture Tune™ mechanism for capturing and storing ID3 tags (including enhanced ID3 tags) of songs

when connected to the Internet (such as via user's PC)

when listening to songs on the FM radio

when listening to songs on the radio (such as in a car)—Locked onto the same frequency as the car radio

when tuned to Internet Radio Stations (such as when roaming, in a Wi-Fi hotspot)

For example, there is disclosed herein a variation of the standard ID3 tag which contains additional information relating to the website address of the radio station, which can later be used by the user to download songs from the Internet (or, from a music store physical location).

The Capture Tune™ mechanism includes functionality for uploading the captured ID3 tags of songs when connected (such as with the user's PC) to the Internet, for the purpose of downloading the desired songs. The tags can be transferred mechanically (USB) to the Internet connected PC or via one of the communication interfaces. For example the apparatus could have a USB dongle with a Zigbee, Bluetooth or UWB interface, which could be inserted into one of the PC ports. The communication would then take place between the Zigbee/Bluetooth/UWB dongle and the apparatus. (Since only tags are being transferred from the apparatus to the PC, data rate and memory size is not an issue. It is only when downloading songs to the apparatus that data rate and memory size become an issue.)

The dongle could fit into a slot in the apparatus. The dongle could be small enough to fit into the apparatus. Like a stylus pen in a PDA (personal digital assistant).

The Capture Tune™ mechanism includes functionality for downloading the songs from authorized Internet vendors. The user can select the audio format (AAC, AC-3, ADPCM, Real Audio, MP3, WMA, OCG Vorbis, etc), from available formats offered by the vendor.

The apparatus includes functionality for uploading and downloading e-credits to pay for downloading songs.

The apparatus includes storage, sufficient to store a plurality of songs, typically in MP3 format, in the form of flash memory and/or HDD as well as removable SD memory sticks.

The apparatus may include a player, for playing stored songs—output either to a headphone jack, or transmitting to car radio, or to an entertainment system via FM transmission or via one of the communication interfaces such as UWB (Ultra Wide Band).

The apparatus may include a recorder, for recording sound bytes and songs

The apparatus may include a microphone, for karaoke

The apparatus includes a human interface (input and output devices) for controlling the operation of the PMD, including menu and display.

The apparatus may include mobile phone capability, including features common to mobile phones, such as contact list, calculator, clock, timer, reminders, etc.

Additionally (not part of the device itself), an enhancement to existing ID3 tags, including:

extra data in the tag file to include the website address & song location linking to the server of the Internet radio station.

Additionally (not part of the device itself), software resident on a user's PC for organizing (including deleting unwanted) captured ID3 tags, uploading the tags, downloading the music, managing e-credits, etc.

Exchange & Sharing

Individuals can transfer music to others using one of the communication interfaces such as Zigbee, NFC, Bluetooth or UWB. The latter interface is probably more ideal as the digital file has to be sent quickly.

The invention has been illustrated and described in a manner that should be considered as exemplary rather than restrictive in character—it being understood that only preferred embodiments have been shown and described, and that all changes and modifications that come within the spirit of the invention are desired to be protected. Undoubtedly, many other “variations” on the techniques set forth hereinabove will occur to one having ordinary skill in the art to which the present invention most nearly pertains, and such variations are intended to be within the scope of the invention, as disclosed herein.

What is claimed is:

1. A portable wireless Internet radio apparatus comprising:
an interface selected from the group consisting of wireless interface, contactless interface and mechanical connection interface for interfacing to an Internet-capable appliance which provides access to the Internet; and
means for capturing song tags.

2. The apparatus of claim 1, further comprising:
a FM receiver for receiving FM radio broadcasts.

3. The apparatus of claim 2, further comprising:
an RF detector for determining the frequency to which a nearby receiver is tuned.

4. The apparatus of claim 2, further comprising:
an FM transmitter for transmitting to a nearby FM receiver.

5. The apparatus of claim 1, wherein:
the means for capturing song tags allows a listener to select tagged songs for subsequent downloading.

6. The apparatus of claim 1, wherein:
the song tags comprise an ID3 tag and a link to the website address of the radio station.

7. The apparatus of claim 1, further comprising:
means for synchronizing with an Internet-based clock to provide a time-out on the use of a music or content download as well as for licensing purposes.

8. The apparatus of claim 1, wherein:
the communication interface is selected from the group consisting of Radio Frequency Identification (contactless), Zigbee, Near Field Communication, Bluetooth, Ultra Wide Band and Infra Red.

9. The apparatus of claim 1, wherein:
the contactless interface can be used for micro-payment, authentication and identification.

10. The apparatus of claim 1 further comprising:
a housing; and
a slot for a smart card (contact or contactless) or fob.

11. The apparatus of claim 1 further comprising:
a housing; and
a slot for the insertion of a communication dongle.

12. A method of downloading songs from the Internet, comprising:
capturing tags of songs of interest to a user; and
subsequently connecting to the Internet and downloading files for the songs of interest based on the captured tags.

13. The method of claim 12, wherein:
the songs are broadcast by a conventional radio station.

14. The method of claim 13, further comprising:
receiving the broadcasts.

15. The method of claim 14, further comprising:
determining a frequency that a nearby, external radio is tuned to.

16. The method of claim 12, wherein:
the songs are broadcast by an Internet radio station.

17. A personal music device (PMD) comprising:
means for capturing tags of songs of interest to a user; and
means for connecting to the Internet and downloading files for the songs of interest based on the captured tags.

18. The PMD of claim 17, wherein:
the songs are broadcast by a conventional radio station.

19. The PMD of claim 18, further comprising:
a receiver in the PMD for receiving broadcasts from the broadcaster.

20. The PMD of claim 19, further comprising:
a detector in the PMD for determining the frequency that an external radio is tuned to.

21. The PMD of claim 17, wherein:
the broadcaster is an Internet radio station.

22. An enhanced song tag comprising:
an ID3 tag; and
a web address of a server for downloading songs.
